(19) United States
(12) Patent Application Publication
(10) Pub. No.: US 2006/0265527 A1
(43) Pub. Date: Nov. 23, 2006

(54) Method and apparatus for increasing efficiency in use of data bus

(75) Inventors: Jian Liu, BeiJing (CN); Fen Zhou, BeiJing (CN); Tian-Yi Zhou, BeiJing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/221,406

(22) Filed: Sep. 6, 2005

(30) Foreign Application Priority Data
May 20, 2005 (CN) 200510070874.5

(51) Int. Cl. G06F 5/00

(52) U.S. Cl. 710/52

(57) ABSTRACT

Techniques for increasing the efficiency in se of a data bus are disclosed. A bus system includes a bus for transferring data, and a device, being coupled to the bus for data transfer, including a functional module providing data required to be transferred over the bus and a first-in-first-out device (FIFO) coupled between the functional module and the bus. The FIFO is provided to store pending data from the functional module before the bus is granted to the functional portion in responding to a bus request (BUS_REQ) for transferring the data over the bus, wherein topside data in the FIFO always drives the bus so that the topside data is immediately transferred over the bus once the bus is granted to the device or the functional module.

### BACKGROUND OF THE INVENTION

1. Field of the Invention

The present invention relates to a bus system, and more particularly to a functional device coupled to the bus without any accessing latency and a method for data exchange between the functional device and the bus.

2. Description of Related Art

Most computer based systems include one or more busses for transferring data between functional devices coupled to the busses or between a functional device and an embedded memory coupled to the busses. The function devices coupled to the busses perform dedicated functions and are somewhat autonomous from other devices, though functions performed by these devices usually involve the exchange of data with other devices on the buses. Examples of the function devices include processor, coder, encoder and so on. Such memory typically performs storage function and exchanges data with a functional device, in a sense, that the memory itself is regarded as a functional device.

It is perhaps necessary to describe the operation of a conventional functional device about the data exchanges. FIG. 1 shows the operation timing diagram of an exemplary functional device. When data in the device needs to be transferred over a bus, assuming that the device sends a bus request (BUS_REQ) to a bus controller on a rising edge of a clock signal. The bus controller determines whether the bus is granted to the device or not according to the priority level of the device. If the priority level of the device is maximal, a bus active command (BUS_ACK) is sent back to the device. An inevitable period delay, such as two cycles illustrated in FIG. 1, from the BUS_REQ to the BUS_ACK is required even if the bus is idle at this time due to the inherent characteristic of the bus controller.

In other words, after the BUS_ACK is sent back to the device or the bus is granted to the device, the device has to delay at least one clock cycle period to start transmitting the data over the bus because the data is required to be latched in a trigger provided in the device before transferred onto the bus, thereby wasting at least one clock cycle of the bus and degradedly affecting the efficiency of the bus.

Therefore there are needs for techniques of improving the efficiency of data exchanges over a bus.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to techniques for improving the efficiency of data exchanges over a bus. According to one aspect of the present invention, a bus system includes a bus for transferring data and a device being coupled to the bus for data exchange. The device includes a synchronous memory module providing data required to be transferred and making a bus request for the data transfer over the bus, and a first-in and first-out device (FIFO) coupled between the synchronous memory module and the bus. The FIFO is used to stores the pending data before the bus is granted to the device. The topside data in the FIFO always drives the bus so that the topside data is immediately transferred over the bus once the bus is granted to the synchronous memory module.

There are numerous functions, benefits and advantages in the present invention, one of them is that the present invention provides a system, a method or an apparatus to transfer data over a data bus more efficiently. The present invention may be implemented in various forms. According to one embodiment, the present invention is a device configured to be coupled to a bus for data exchange, the device comprises a functional module providing data to be transferred over the bus; a first-in and first-out device (FIFO), coupled between the functional module and the bus, start buffering the data from the functional module before the bus is granted to the functional module in responding to a bus request (BUS_REQ) for the data to be transferred over the bus, wherein topside data in the FIFO drives the bus so that the topside data is immediately transferred over the bus once the bus is granted to the functional portion.

According to another embodiment, the present invention is a bus system that comprises a bus for transferring data; and a device, being coupled to the bus for data transfer, including a functional module providing data required to be transferred over the bus and a first-in-first-out device (FIFO) coupled between the functional module and the bus, the FIFO temporally storing pending data from the functional module before the bus is granted to the functional portion in responding to a bus request (BUS_REQ) for transferring the data over the bus, wherein topside data in the FIFO always drives the bus so that the topside data is immediately transferred over the bus once the bus is granted to the device or the functional module.

According to yet another embodiment, the present invention is a method for exchanging data in a bus system, the bus system including a bus, a bus controller and a device coupled to the bus, the device including a functional module providing data to be transferred and a first-in-first-out device (FIFO) coupled between the functional module and the bus, the method comprises making a bus request (BUS_REQ) to the bus controller for transferring over the bus; starting to buffering the data from the functional module in the FIFO; and transferring immediately the data from the FIFO upon receiving a bus active command from the bus controller.

One of the objects, features, and advantages of the present invention is to provide techniques for data exchanges over a bus in order to increase the efficiency in use of the bus.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 shows the operation timing diagram of an exemplary functional device;

FIG. 2 shows an exemplary bus system in accordance with one embodiment of the present invention; and

FIG. 3 shows the operation timing diagram timing of the bus system in accordance with one embodiment of the present invention.

### DETAILED DESCRIPTION OF THE PREFERRED MBODIMENTS

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

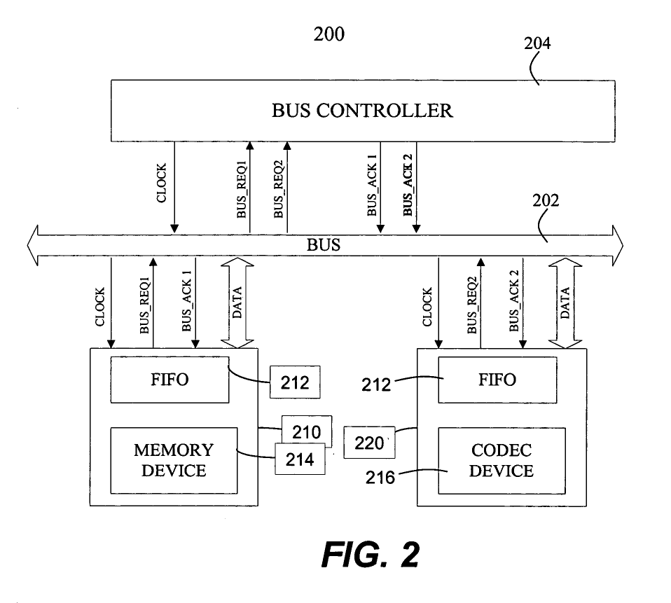

Referring now to the drawings, in which like numerals refer to like parts throughout the several views. FIG. 2 shows an exemplary bus system 200 in accordance with one embodiment of the present invention. The bus system 200 includes a bus 202, a bus controller 204, a plurality of functional devices, where only two 210 and 220 are shown. The bus controller 204 is configured to determine which one of the devices is permitted to transfer data over the bus. Depending on functions of the devices, each of the devices includes a FIFO 212, and a synchronous memory module 214 or a codec module 216.

To facilitate the description of the present invention, the synchronous memory module 214 or a codec module 216 is referred to as a functional portion or module dictating the function of the device. Accordingly, the device 210 may be a memory device (e.g., a USB flash drive), the device 220 may be an interface to a camera (e.g., a DSP chip to encode or decode image data). To avoid obscuring the aspects of the present invention, examples of such devices are not to be further listed.

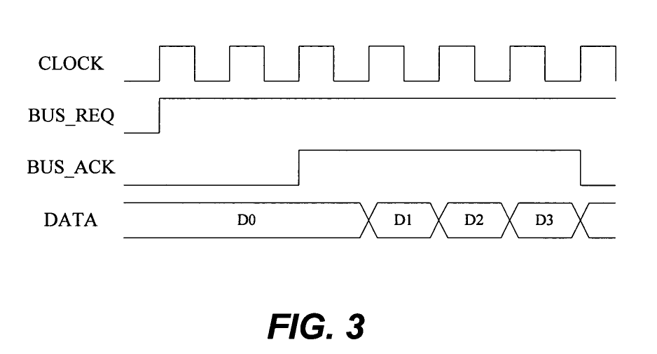

As shown in FIG. 2, the FIFO 212 is coupled between the functional module 214 or 216 and the bus 202. In one embodiment, a D-type flip-flop (trigger) is configured as the FIFO to output the data at the current cycle of the clock. To fully understand the operation of the bus system 200, FIG. 3 is provided to show the corresponding timing diagram with respect to the operation of the bus system 200.

When data in the functional device 210 need to be transferred over the bus 202, the memory module 214 makes a bus request (BUS_REQ) to a bus controller 204 on the rising edge of a clock signal of the bus. The bus controller 204 determines whether the bus is granted to the functional device 210 or not according to the priority level of the functional device 210. If the priority level of the functional device 210 is maximal, a bus active command (BUS_ACK) is sent back to the functional device 210. The functional device 210 then start transferring the pending data from the synchronous module 214 into the FIFO 212 until the FIFO 212 is full, before the BUS_ACK is received back. It should be noted that the FIFO 212 is provided to temporally store the pending data. In the one embodiment, the pending data is written into the FIFO 212 before the BUS_REQ is sent or at the same time as the BUS_REQ is made.

Once the BUS_ACK is received, the FIFO 212 outputs the topside data to a destination device over the bus because the topside data in the FIFO drives the bus all the time, not requiring to delay one-clock cycle described as the prior art system. In other words, the topside data may be transferred over the bus in the first cycle of the clock of the bus after the BUS_ACK is received. After the topside data in the FIFO 212 is outputted, the next data in the FIFO 212 will be pushed onto the topside and simultaneously the remaining data required to be transferred in the synchronous memory device 214 is written into the FIFO 212 until the data transfer is finished. The transfer rate on the bus is equal to the output rate of the FIFO 212, so the FIFO 212 shall have no adverse effect on the transfer rate on the bus

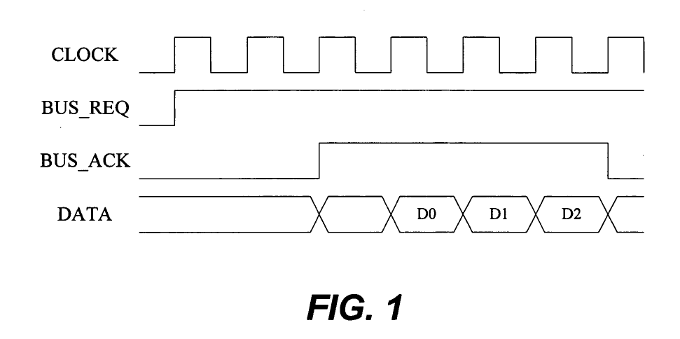

Comparing FIG. 1 and FIG. 3, it can be appreciated that one clock cycle latency is saved in the bus system of the present invention after the BUS_ACK is received, thereby increasing the efficiency in use of the bus.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A device configured to be coupled to a bus for data exchange, the device comprising:
a functional module providing data to be transferred over the bus;
a first-in and first-out device (FIFO), coupled between the functional module and the bus, start buffering the data from the functional module before the bus is granted to the functional module in responding to a bus request (BUS_REQ) for the data to be transferred over the bus, wherein topside data in the FIFO drives the bus so that the topside data is immediately transferred over the bus once the bus is granted to the functional portion.

2. The device as claimed in claim 1, wherein after the topside data in the FIFO is outputted, a next piece of data in the FIFO is pushed onto the bus and simultaneously receives a next piece of data from the functional module till the data is complete.

3. The device as claimed in claim 1, wherein the FIFO temporally stores pending data from the functional module before the functional module makes the bus request or at the same time as the bus request is made.

4. The functional device as claimed in claim 3, wherein the FIFO is a D trigger.

5. The functional device as claimed in claim 1, wherein the data is immediately transferred to the bus upon receiving an acknowledge signal from a bus controller.

6. The functional device as claimed in claim 1, wherein the functional module is a synchronous memory module or a codec module.

7. A bus system comprising:
a bus for transferring data;
a device, being coupled to the bus for data transfer, including a functional module providing data required to be transferred over the bus and a first-in-first-out device (FIFO) coupled between the functional module and the bus, the FIFO temporally storing pending data from the functional module before the bus is granted to the functional portion in responding to a bus request (BUS_REQ) for transferring the data over the bus, wherein topside data in the FIFO always drives the bus so that the topside data is immediately transferred over the bus once the bus is granted to the device or the functional module.

8. The bus system as claimed in claim 7, wherein after the topside data in the FIFO is outputted, a next piece of data in the FIFO is pushed onto the bus and simultaneously the data providing by the synchronous memory device may be read into the FIFO until the data transference is finished.

9. The functional device as claimed in claim 8, wherein the data is immediately transferred to the bus upon receiving an acknowledge signal from a bus controller.

10. The bus system as claimed in claim 7, wherein the FIFO temporally stores pending data from the functional module before the functional module makes the bus request or at the same time as the request is made.

11. The bus system as claimed in claim 7, wherein the functional module is a synchronous memory module or a codec module.

12. A method for exchanging data in a bus system, the bus system including a bus, a bus controller and a device coupled to the bus, the device including a functional module providing data to be transferred and a first-in-first-out device (FIFO) coupled between the functional module and the bus, the method comprising
making a bus request (BUS_REQ) to the bus controller for transferring over the bus;
starting to buffering the data from the functional module in the FIFO; and
transferring immediately the data from the FIFO upon receiving a bus active command from the bus controller.

13. The method as claimed in claim 12, wherein topside data in the FIFO always drives the bus so that the topside data is immediately transferred over the bus once the bus is granted to the device or the functional module.

14. The method as claimed in claim 13, wherein after the topside data in the FIFO is outputted, a next piece of data in the FIFO is pushed onto the bus and simultaneously a next piece of data from the functional module is read into the FIFO until the data is exhausted.

15. The method as claimed in claim 14, wherein the functional module is a synchronous memory module or a codec module.

16. The method as claimed in claim 12 further comprising simultaneously transferring the topside data over the bus.

17. The method as claimed in claim 12, wherein starting to buffer the data is preformed before the functional portion makes the BUS_REQ or at the same time as the BUS_REQ is made.

18. The method as claimed in claim 12, wherein the data is immediately transferred to the bus without losing one clock cycle.
